(19) United States
(12) Patent Application Publication
(10) Pub. No.: US 2009/0285704 A1
(43) Pub. Date: Nov. 19, 2009

(54) OIL-LESS AIR COMPRESSOR

(76) Inventor: Fei-Tyh CHUANG, Shulin City (TW)

Correspondence Address: SINORICA, LLC, 2275 Research Blvd., Suite 500, ROCKVILLE, MD, 20850, US

(21) Appl. No.: 12/122,852

(22) Filed: May 19, 2008

(51) Int. Cl. F04B 35/04; F16J 1/09

(52) U.S. Cl. 417/415; 92/183

(57) ABSTRACT

The present invention provides an air compressor, characterized in that the piston head has a concave portion having a plurality of through holes therein and a reed piece having a smaller area than that of said concave portion is disposed in said concave portion, said reed piece having an opening in its center to allow a seizing member, respectively, which is seized on a top center of said piston head, for freely moving through said opening, and said seizing member having a confining portion to confine said reed piece within a predetermined space for moving so that said reed piece moves toward or away from said plurality of through holes by means of reciprocally moving said piston rod to improve the air compression efficiency while said air compressor is operating.

### BACKGROUND OF THE INVENTION

1. Field of the Invention

The present invention relates to an oil-less air compressor, and more particularly, to a piston rod and the related components for improving efficiency.

2. Description of Related Art

FIG. 1A shows a conventional oil-less air compressor, which includes a motor 11, an idler 12 and a bearing 13 transmitting kinetic energy produced by the motor 11 to a piston rod 14 for the latter to move in a crankcase 15 in rotary motion and a piston head 16 of the piston rod 14 to reciprocatingly move in an air cylinder 17, and a check valve 162 is provided at an air outlet direction 18 of the air cylinder 17. When the piston head 16 is in a downward return stroke, external air is admitted into the crankcase 15 via an air inlet direction 19 thereof and enters into the air cylinder 17 via the piston head 16. And, when the piston head 16 is in an upward compress stroke, air in the air cylinder 17 is compressed to pass through the check valve 162 and discharged via the air outlet direction 21 into an externally connected air tank (not shown) for storage. Moreover, the piston head 16 of the piston rod 14 is provided at a top with a recess 161 having a through hole (not shown) formed therein, so that a check valve 162 is loosely screwed to the through hole in the recess 161. When the piston head 16 is in a downward return stroke, air is admitted into the crankcase 15 and enters into the air cylinder 17 via the check valve 162; and when the piston head 16 is in an upward compress stroke, the check valve 162 bears against the recess 161 with a gap left between the check valve 162 and the recess 161 to produce residual air pressure thereat, forming an adverse influence on the smooth movement of air into and out of the air cylinder 17.

U.S. Application No. 20060045768 discloses another conventional oil-less air compressor which includes a piston rod 20, as shown in FIG. 1B. The piston rod 20 has a piston head 21 on which a centered fixing hole 210 and a plurality of through holes 211 spaced around the fixing hole 210 are provided, and a disk-like check valve 22 is screwed to the fixing hole 210 of the piston head 21 by means of a screw 23 through a centered through hole 220. It is characterized in that there is not formed any gap between the check valve 22 and the piston head 21 (shown in FIG. 1C) so that no residual air pressure would be formed on the piston head 21 to cause an adverse effect on the smooth movement of air into and out of the air cylinder (not shown) while the piston head 21 is in the upward compress stroke or in a downward return stroke. However, the check valve 22 is subject to deformation because the check valve 22 is tightly bearing against the piston head 21 so frequently when the piston head 21 is in an upward compress stroke.

### SUMMARY OF THE INVENTION

To overcome the shortcomings in the prior art, the present invention provides an oil-less air compressor. The oil-less air compressor comprises a crankcase, a cylinder, and a piston rod having a piston head, wherein the piston rod moves in the crankcase in rotary motion while the piston head moves in the cylinder in linear motion for external air to enter the crankcase via an air inlet thereof and then an air cylinder and for the external air in the crankcase to be discharged from the air cylinder via an air outlet thereof; it is characterized in that the piston head has a concave portion having a plurality of through holes therein and a reed piece having a smaller area than that of the concave portion is disposed in the concave portion, the reed piece having an opening in its center to allow a seizing member, respectively, which is seized on a top center of the piston head, for freely moving through the opening, and the seizing member having a confining portion to confine said reed piece within a predetermined space for moving so that the reed piece moves toward or away from the plurality of through holes by means of reciprocally moving the piston rod to improve the air compression efficiency while the air compressor is operating.

Accordingly, it is a primary objective of the present invention to provide an oil-less air compressor, wherein the piston rod of the oil-less air compressor provides a predetermined space between a seizing member and the piston head by means of screwing the seizing member loosely to the top of the piston head so as to allow a reed piece freely moving within the predetermined space to reduce damage of the reed piece as well as to improve air compression efficiency.

Another objective of the present invention is to provide an oil-less air compressor, wherein the piston rod of the oil-less air compressor provides a predetermined space between a seizing member having a annular shoulder and the piston head by means of screwing the seizing member tightly to the top of the piston head, so as to allow a reed piece freely moving around the outer circumstance of the annular shoulder within the predetermined space to reduce damage of the reed piece as well as to improve air compression efficiency.

A further objective of the present invention is to provide an oil-less air compressor, wherein a collar is disposed between the seizing member and the piston head to provide a predetermined space by means of screwing the seizing member tightly to the top of the piston head, so as to allow a reed piece freely moving around the outer circumstance of the collar within the predetermined space to reduce damage of the reed piece as well as to improve air compression efficiency.

### BRIEF DESCRIPTION OF THE DRAWINGS

FIG. 1A is a schematic view illustrating a prior art of a conventional oil-less air compressor.

FIG. 1B is a schematic view illustrating a prior art of the piston rod of a conventional oil-less air compressor.

FIG. 1C is a sectional view illustrating a prior art of the piston rod of the conventional oil-less air compressor shown in FIG. 1B.

FIG. 2 is a sectional view illustrating a piston rod in accordance with a first preferred embodiment of the present invention.

FIG. 3 is a sectional view illustrating a piston rod in accordance with a second preferred embodiment of the present invention.

FIG. 4 is a sectional view illustrating a piston rod in accordance with a third preferred embodiment of the present invention.

FIG. 5 is a sectional view illustrating a reed piece in accordance with the present invention.

### DETAILED DESCRIPTION OF THE PREFERRED EMBODIMENTS

The present invention relates to oil-less air compressor. The principle used therein regarding the air compression or air flow of the oil-less air compressor has been known to those of ordinary skill in the art and is therefore not described in detail in the following description. Also, it is to be understood that the drawings referred to in the following description are merely schematic views showing features of the present invention and are not made according to their actual dimensions.

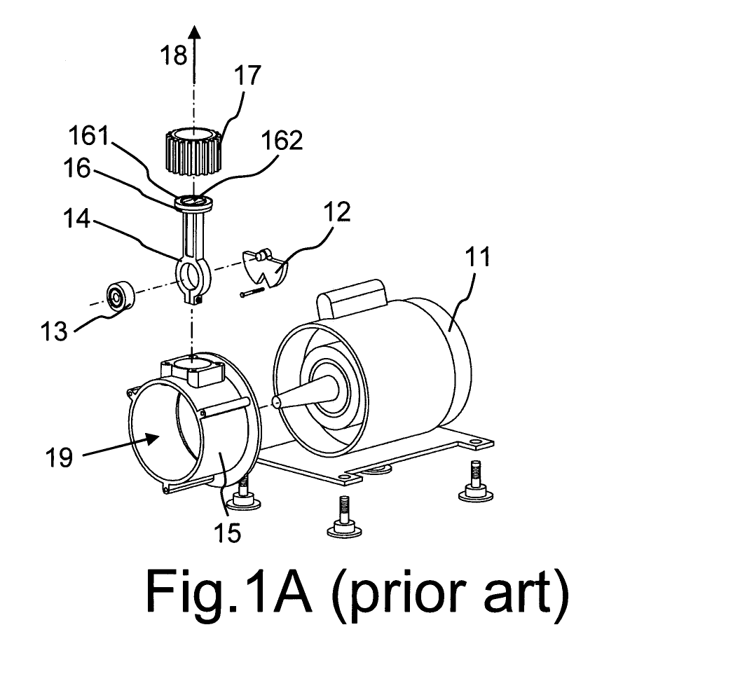

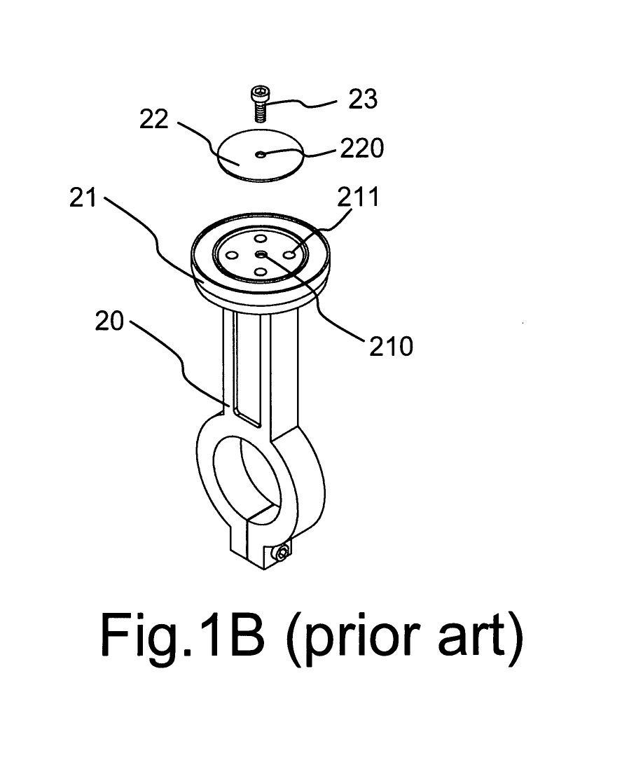

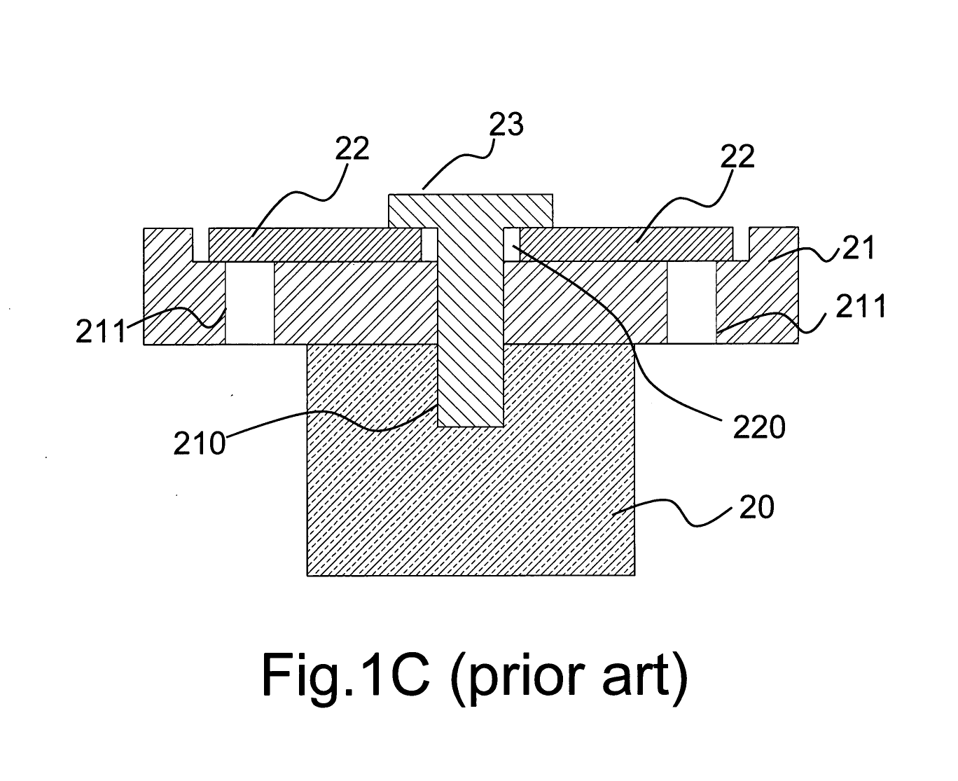

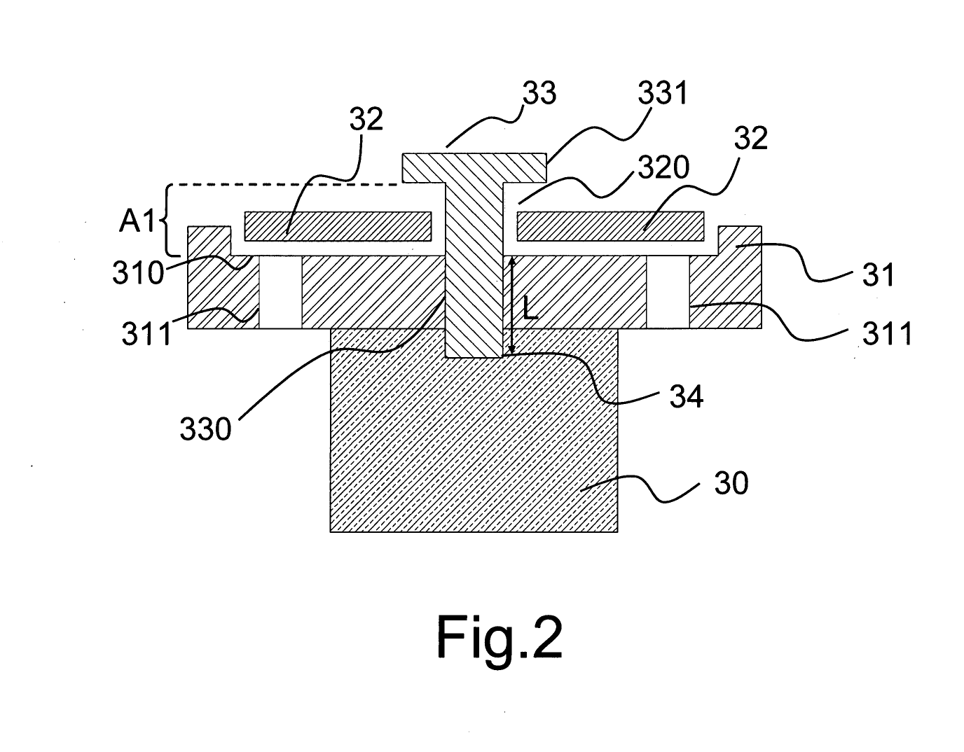

Referring to FIG. 1A, the oil-less air compressor comprises a crankcase 15, a cylinder 17, and a piston rod 14 having on its top side a piston head 16. The piston rod 14 moves in the crankcase 15 in rotary motion while the piston head 16 moves in the cylinder 17 in linear motion for external air entering the crankcase 15 and an air cylinder 17 along an air inlet direction 19, and then the external air in the crankcase 15 is discharged from the air cylinder 17 along an air outlet direction 18. The oil-less air compressor of the present invention has a featured piston rod 30, as shown in FIG. 2, which comprises a piston head 31, a reed piece 32, and a seizing member 33. The piston head 31 has a concave portion 310, wherein the concave portion 310 is provided with a center hole 34 and a plurality of through holes 311, which are spaced around the center hole 34, for allowing the external air flow therebetween.

In the above embodiment, the seizing member 33 has a confining portion 331 and a thread portion 330 for being screwed into the center hole 34 of the concave portion 310 in a predetermined length L so as to form a predetermined space A1 between the confining portion 331 and the piston head 31. The reed piece 32 has a smaller contact area than that of the concave portion 310 for allowing the reed piece 32 to be disposed in the concave portion 310. The reed piece 32 has an opening 320 in its center, compared to the seizing member 33, the opening 320 is larger than the outer diameter of the thread portion 330 and smaller than that of the confining portion 331, so that the reed piece 32 could freely move in the predetermined space A1. Therefore, when the air compressor operates to make the piston rod 30 move reciprocally, the reed piece 32 may freely move toward or away from the plurality of through holes 311 in the predetermined space A1 so as to prevent the bending or torsion of the reed piece 32 and reduce damage of the reed piece 32. Additionally, referring to FIGS. 1B and 1C, the reed piece in the prior art is fastened to the piston head, the through holes 211 are fully covered, but partially uncovered during the air compression operation; while in this preferred embodiment of the present invention, since through holes 311 are fully covered and fully uncovered by the freely moving reed piece 32, the air compression efficiency is hence improved.

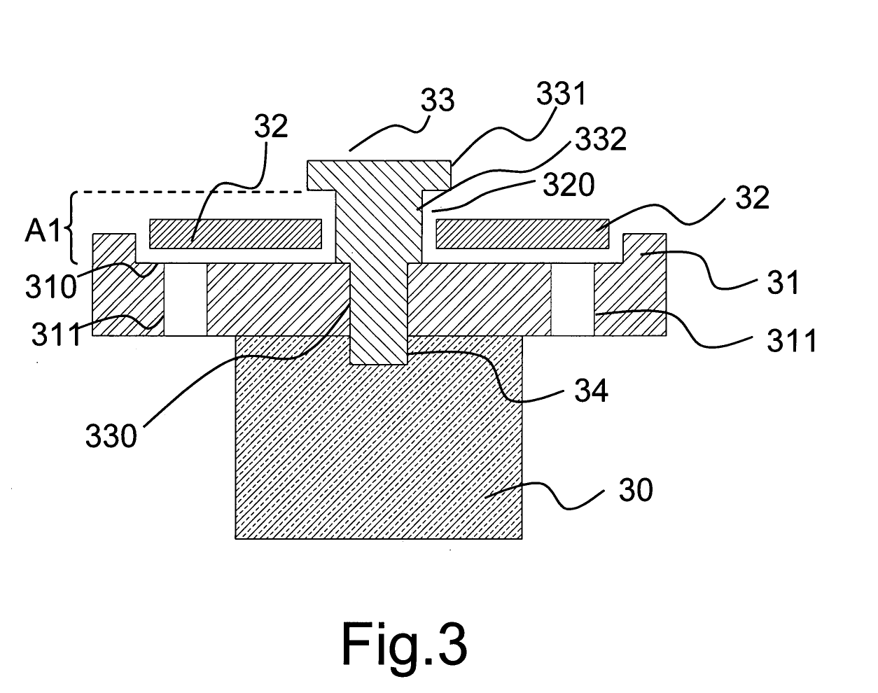

FIG. 3 illustrates a sectional view of another piston rod of oil-less air compressor in accordance with a second preferred embodiment of the present invention. The seizing member 33 has a confining portion 331 and a thread portion 330 for being tightly screwed into the center hole 34 of the concave portion 310, and an annular shoulder 332 having a outer diameter smaller that that of the confining portion 331 but larger than that of the thread portion 330, so as to form a predetermined space A1 between the confining portion 331 and the piston head 31. The reed piece 32 has a smaller contact area than that of the concave portion 310 for allowing the reed piece 32 to be disposed in the concave portion 310. The reed piece 32 has an opening 320 in its center, compared to the seizing member 33, the opening 320 is larger than the outer diameter of the annular shoulder 332 and smaller than that of the confining portion 331, so that the reed piece 32 could freely move in the predetermined space A1.

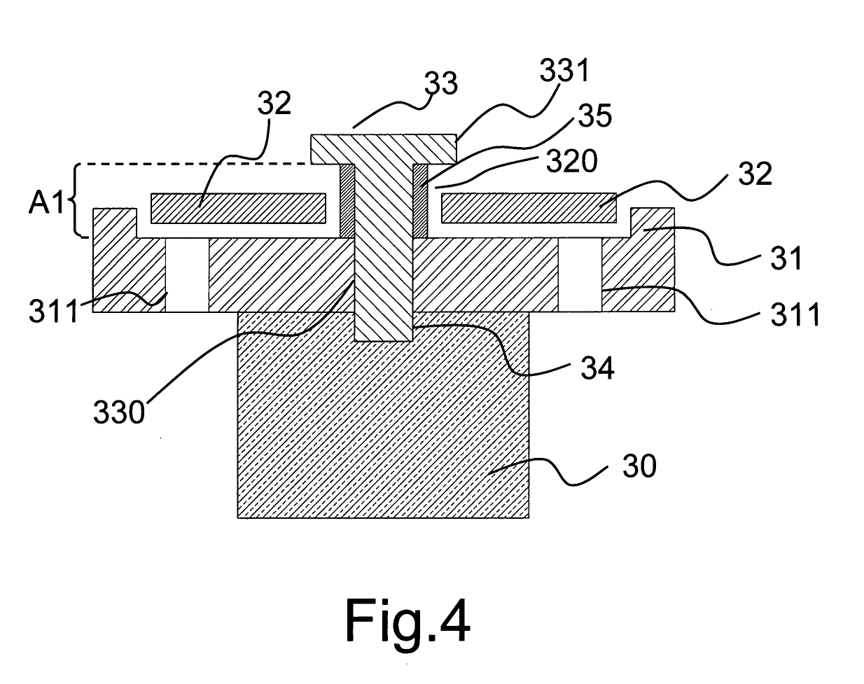

FIG. 4 illustrates a sectional view of yet another piston rod of an oil-less air compressor in accordance with a third preferred embodiment of the present invention. A collar 35 is further provided to be disposed between the confining portion 331 of the seizing member 33 and the concave portion 310 of the piston head 31, as the thread portion 330 being tightly screwed into the center hole 34, so as to form a predetermined space A1 between the confining portion 331 and the piston head 31. The reed piece 32 has an opening 320 in its center, compared to the seizing member 33, the opening 320 is larger than the outer diameter of the collar 35 and smaller than that of the confining portion 331, so that the reed piece 32 could freely move in the predetermined space A1.

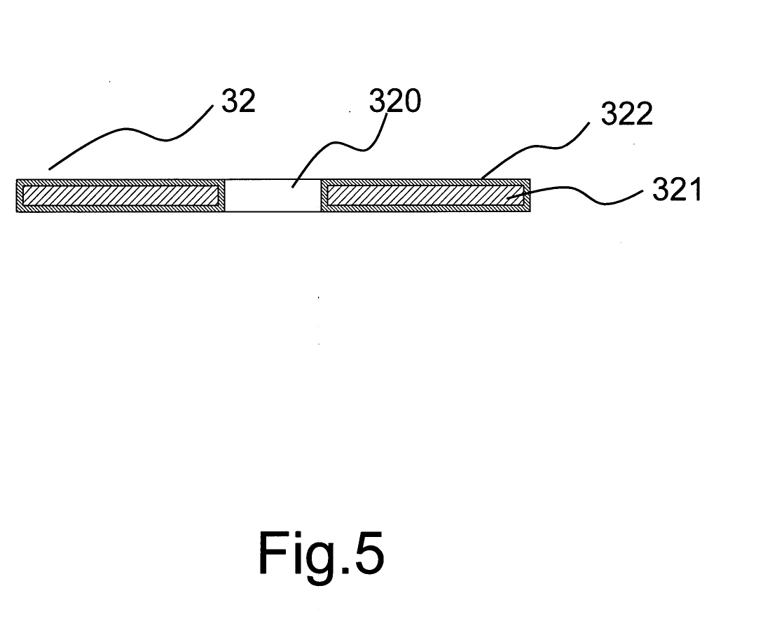

In the above embodiments, the through holes 311 can be arranged in symmetry preferably. Besides, the reed piece 32 is made of metal for the purpose of increasing the stiffness, or the reed piece is made of plastic or rubber for the purpose of reducing the noise while the reed piece 32 is moving and contacting the piston head 31. Besides, for reducing the noise while increasing the stiffness, the reed piece 32 may further have an internal part 321 of metal and an external part 322 of plastics or rubbers overlays the internal part 321 as shown in FIG. 5.

The present invention has been explained in relation to preferred embodiments thereof, which are presented for illustrative purposes only, and not intended to limit the scope of the present invention. Furthermore, the description of the present invention should be readily understood and can be practiced by those skilled in the art. Therefore, alterations and modifications can be made to the present invention without departing from the scope or spirit of the present invention. Such alterations and modifications should be construed as equivalent variations or designs made according to the spirit of the present invention and are encompassed by claims.

1. An air compressor, comprising a crankcase, a cylinder, and a piston rod having a piston head, said piston rod moving in said crankcase in rotary motion while said piston head moving in said cylinder in linear motion for external air to enter said crankcase via an air inlet thereof and then an air cylinder and for said external air in said crankcase to be discharged from said air cylinder via an air outlet thereof; characterized in that
said piston head has a concave portion having a plurality of through holes therein for air flow, a reed piece having a smaller area than that of said concave portion is disposed in said concave portion, said reed piece having an opening in its center to allow a seizing member being seized on a top center of said piston head, said seizing member having a confining portion larger than the opening of said reed piece so as to form a predetermined space for confining said reed piece freely moving toward or away from said plurality of through holes by means of reciprocally moving said piston rod while said air compressor is operating.

2. The air compressor of claim 1, wherein said seizing member further comprising a thread portion for threading into said concave portion in a predetermined length so as to confine said reed piece for moving within a predetermined space between said confining portion and said concave portion.

3. The air compressor of claim 1, further comprising a collar disposed between said confining portion of said seizing member and said concave portion, and the outer diameter of said collar being smaller than said opening of said reed piece so as to form a predetermined space for confining said reed piece for moving around the outer circumstance of said collar.

4. The air compressor of claim 1, wherein said seizing member further comprising a annular shoulder provided between said confining portion and said concave portion, and the outer diameter of said annular shoulder being smaller than said opening of said reed piece so as to form a predetermined space for confining said reed piece for moving around the outer circumstance of said annular shoulder.

5. The air compressor of any one of claims 2, 3, or 4, wherein said reed piece is metal.

6. The air compressor of any one of claims 2, 3, or 4, wherein said reed piece is plastic or rubber for reducing noise while said reed piece is moving.

7. The air compressor of any one of claims 2, 3, or 4, wherein said reed piece has an internal part of metal and an external part of plastics or rubbers overlaying said internal part for reducing noise while said reed piece is moving.

8. The air compressor of any one of claims 2, 3, or 4, wherein said through holes are arranged in symmetry.
